(19) United States
(12) Patent Application Publication
(10) Pub. No.: US 2008/0146168 A1
(43) Pub. Date: Jun. 19, 2008

(54) Methods of Enhancing Power Amplifier Linearity

(75) Inventors: Martin Gordon Jesson, Cambridgeshire (GB); Gareth John Bath, Essex (GB); Philip John Macphail, Cambridge (GB)

Correspondence Address: KENYON & KENYON LLP, 1500 K STREET N.W., SUITE 700, WASHINGTON, DC, 20005, US

(73) Assignee: SiGe Semiconductor Inc., Ottawa (CA)

(21) Appl. No.: 10/588,728

(22) PCT Filed: Feb. 8, 2005
(86) PCT No.: PCT/CA05/00144

§ 371 Date: Aug. 8, 2006

Related U.S. Application Data
(60) Provisional application No. 60/542,297, filed on Feb. 9, 2004.

(51) Int. Cl. H04B 15/00; H04B 1/40

(52) U.S. Cl. 455/90.2; 455/114.3

(57) ABSTRACT

A novel method of enhancing power amplifier linearity is disclosed. The invention is for use within a transceiver system and provides a method in the digital domain for predistorting a digital modulated signal to compensate for the non-linearity properties of the power amplifier and other components within the transmitter system. The RF output signal of the transmitter circuit is sampled and the corresponding amplitude and phase are detected using a receiver circuit. In dependence upon the amplitude and phase information, a look-up table is indexed to select the predistortion data and predistortion of the digital modulated signal occurs within the predistortion circuit.

### FIELD OF THE INVENTION

The invention relates to the field of RF transmitter circuits and more specifically to the field of RF transmitter circuits that employ a predistorter circuit.

### BACKGROUND OF THE INVENTION

Modern digital wireless communication systems use complex modulation schemes in order to provide data between a transmitter and a receiver at high data rates using a modulated wireless signal within a limited spectral bandwidth.

These modulated signals tend to have high peak-to-mean power ratios and require highly linear amplification. One example of such modulation is the OFDM that is used in a wireless LAN standard 802.11g, as is well known to those of skill in the art. These modulation schemes require high modulation accuracy due to a number of bits of information coded onto each carrier signal.

Power amplifiers (PAs) are utilized in a majority of wireless LAN transmitters. These transmitters operate with a mean output signal power that is much lower than a 1 dB compression point of the PA. The difference between the mean output signal power and the 1 dB compression point of the amplifier is often called linearity back-off. Clearly, it is a design objective to determine a degree of the linearity back-off relative to a required linearity. This determination of degree is necessary to provide adequate linearity for the PA.

An algorithm for the adaptation of the pre-distortion values is described in the following conference paper: K Wesolowski and J Pochmara, “Efficient Algorithm for Adjustment of Adaptive Predistorter in a Transmitter for OFDM Signals”, IEEE Vehicular Technology Conference, Fall 2000.

In U.S. Pat. No. 6,275,685 B1 Wessel et al disclose a linear amplifier architecture comprising a power amplifier, a feedback circuit and a control element using an envelope detector. The method disclosed uses a pre-distorter circuit that adapts to the circuit. The disadvantage of the architecture and method disclosed in U.S. Pat. No. 6,275,685 B1 is that analog predistortion is applied to an RF input signal. It is a disadvantage that the complexity of the power amplifier is high, the die size and the costs are also significant.

It is well understood to those skilled in the art of PA design that operating a RF power amplifier at a power much lower than its maximum capability reduces the efficiency of conversion of DC power to RF power. Moreover, the linearity back-off becomes a larger disadvantage, due to a larger efficiency impact, as the RF power requirement increases. In addition, it becomes more difficult to realize such a PA with the required performance using low cost technology.

### SUMMARY OF THE INVENTION

The objective of the present invention is to improve the performance of a transmitter system that utilizes a conventional PA of moderate linearity so that it meets modulation requirements in accordance with predetermined modulation schemes and with low cost and low power consumption.

In accordance with the invention there is provided a method of transmitting a RF signal comprising: providing of a lookup table (LUT) for storing of predistortion data; providing a power amplifier circuit for receiving a first analog RF signal and for providing the RF signal therefrom; receiving of a digital modulated signal; indexing of the LUT to provide indexed predistortion data; predistorting the digital modulated signal in dependence upon the indexed predistortion data to form a predistorted digital modulated signal; converting the predistorted digital modulated signal into an analog modulated signal; amplifying the analog modulated signal using the power amplifier to form the RF signal; sampling a portion of the RF signal; and, varying the index within the LUT for other than continuously changing the predistortion data that is used for predistorting of the digital modulated signal in dependence upon the sampled RF signal.

### BRIEF DESCRIPTION OF THE DRAWINGS

Exemplary embodiments of the invention will now be described in conjunction with the following drawings, in which:

FIG. 1 illustrates an envelope based adaptation of a transmitter circuit;

FIG. 2 illustrates a quadrature based adaptation of a transmitter circuit; and,

FIG. 3 illustrates the method steps in operating a transmitter circuit, such as that illustrated in FIGS. 1 and 2.

### DETAILED DESCRIPTION OF EMBODIMENTS OF THE INVENTION

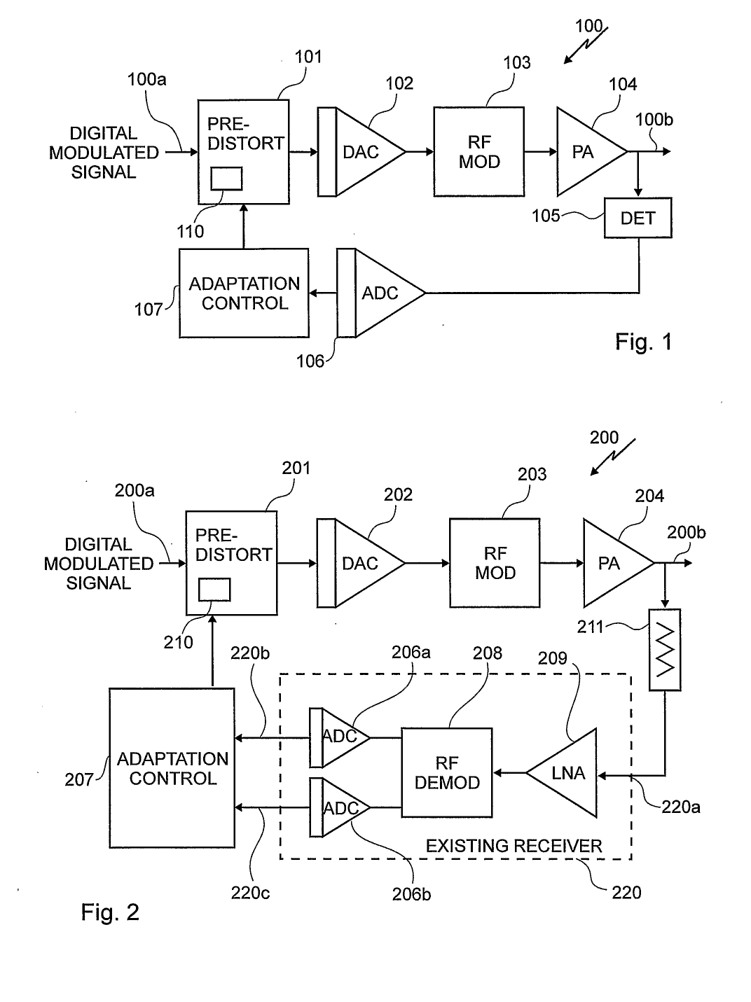

FIG. 1 illustrates a portion of a transmitter system 100 having an input port 100a for receiving a digital modulated signal and having an output port 100b for providing a radio frequency (RF) signal therefrom. A digital predistorter circuit 101 has an input port coupled to port 100a for receiving the digital modulated signal and for providing a predistorted digital modulated signal from an output port thereof. Disposed within the digital predistorter circuit 101 is a lookup table (LUT) 110 for storing of predistortion data. Coupled to an output port of the digital predistorter circuit 101 is a digital to analog converter (DAC) 102 for converting the predistorted digital modulated signal to an analog representation thereof. A RF modulator 103 receives this analog representation and modulates this signal to form a modulated signal that is provided to an input port of a power amplifier (PA) 104 circuit. The PA 104 amplifies the modulated signal and provides it to the output port 100b of the transmitter 100. An envelope detector 105 is coupled to the PA 104 for receiving a portion of the amplified modulated signal and for providing this signal to an analog to digital converter (ADC) 106. The ADC converts the portion of the amplified modulated signal into a digital representation thereof for provision to an adaptation control circuit 107, which is then coupled to the predistortion circuit 101 for, at least in part, controlling the operation thereof using a control signal.

The control signal is used to index the LUT 110 for selecting of predistortion data stored therein for use by the predistorter circuit 101 in predistorting of the digital modulated input signal.

In operation of the transmitter 100, the input signal to the PA 104 is predistorted using the predistortion circuit 101 by accessing stored values within the LUT 110 in the digital domain. The input signal that is represented in a digital format is adjusted by the parameters in the look-up table to form an alternative input signal that is downstream provide to the PA 104 that compensates for the expected non-linearities of the PA 104 and optionally other components in the signal path. This technique of adjusting the input signal while it is still in a digital format takes advantage of the continuing decrease in size and cost of digital circuits. It is also preferable to adapt the values stored in the LUT 110 to compensate for variations in the performance of the RF PA 104 for external conditions, such as changes in temperature, supply voltage or output load.

For the transmitter circuit shown in FIG. 1, the varying of predistortion parameters based upon the control signal is dependent upon the amplitude of the transmitted signal alone, where this sampling of the amplitude of the transmitted signal alone is performed in conjunction with the high-speed envelope detector 105.

FIG. 2 illustrates a preferred embodiment of the invention, a portion of a transmitter circuit 200 that is a variation of the portion of the transmitter circuit 100 shown in FIG. 1. An input port 200a is provided for receiving a digital modulated signal and an output port 200b is provided for emitting a RF signal therefrom. A digital predistorter circuit 201 has an input port coupled to input port 200a for receiving the digital modulated signal and for providing a predistorted digital modulated signal from an output port thereof. Disposed within the digital predistorter circuit 201 is a lookup table (LUT) 210 for storing of predistortion data. Coupled to an output port of the digital predistorter circuit 201 is a digital to analog converter (DAC) 203 for converting the predistorted digital modulated signal to an analog representation thereof. A RF modulator 203 receives this analog representation and modulates this signal to form a modulated signal that is provided to an input port of a power amplifier (PA) 204 circuit. The PA 204 amplifies the modulated signal and provides it to the output port 200b of the transmitter 200. An attenuator 211 is disposed between an input port 220a of an existing receiver circuit 220 and the output port 200b. The existing receiver circuit includes a low noise amplifier (LNA) circuit 209, a RF demodulator circuit 208, a first ADC 206a and a second ADC 206b. Output ports of the two ADCs form first and second output ports, 220b and 220c, of the existing receiver circuit 220.

The LNA 209 receives a portion of the RF output signal power through the attenuator 211 and provides an amplified version thereof to the RF demodulator circuit 208, in the form of a quadrature down-conversion mixer for providing first and second demodulated signals, ‘I’ and ‘Q’ signals, respectively, therefrom. Each of these demodulated signals is then converted to the digital domain using the first and second ADCs 206a and 206b. An adaptation control circuit 207 is provided external to the existing receiver circuit 220 for receiving of the digitally represented demodulated signals. The adaptation control circuit 207 is coupled to the predistortion circuit 201 for, at least in part, controlling the operation thereof using a control signal. The control signal is used to index the LUT 210 for selecting of predistortion data stored therein for use by the predistorter circuit 201 in predistorting of the digital modulated input signal.

In the preferred embodiment, both amplitude and phase of the RF output signal are sampled using the existing receiver circuit 220. Preferably, the quadrature down-conversion mixer utilizes circuitry of an existing wireless local area network (WLAN) receiver in order to reduce electrical component costs.

For determining optimal predistortion data for the transmitter circuit 100, 200, a predetermined symbol pattern is provided concurrently with the digital modulated signal at a same carrier frequency. The existing receiver circuitry 220, or detector circuit 105, samples the RF output signal that includes a variation of the predetermined symbol pattern. The variation of the predetermined symbol pattern is dependent upon the transmitter circuit distortion during signal propagation from the input port 100a, 200a to the output port 100b, 200b thereof. A comparison is performed between the predetermined symbol pattern and the variation of the predetermined symbol pattern and in dependence upon this comparison the control signal provided from the adaptation control circuit 107, 207 is varied in order to change an index within the LUT 110, 210 that is used for indexing of the predistortion data stored therein. The index of the LUT 110, 210 is varied until a difference between the predetermined symbol pattern and the variation of the predetermined symbol pattern is preferably minimized. Preferably the predetermined symbol pattern is graphically represented by a sine wave.

In both embodiments, the digital circuits sample a portion of transmitted RF signal. This portion preferably contains the part of the transmitted RF signal with largest amplitude components, typically the part containing user data, and at times the variation of the predetermined symbol pattern at the carrier frequency. The digital circuits construct an ideal transmit signal due to the sampled transmitted RF signal and take into account any pulse shaping or reconstruction filters that are disposed in the signal path leading up to the RF power amplifier. This ideal signal is compared with samples of the sampled actual predetermined symbol pattern transmitted and the error is computed. For this computation, a precise time alignment of the two signals is implemented, which is the predetermined symbol pattern and the sampled predetermined symbol pattern. Preferably the time alignment is achieved by a correlation or error minimization technique and may use predetermined values based on prior knowledge of the analog circuits. Once the time difference is found, a slow, and preferably other than continuous variation of indexing of entries of predistortion data within the LUT takes place.

The computed error in the transmitted RF signal and knowledge of the ideal signal at the same instant in time are used to vary the indexing of the predistortion data that is stored in the LUT. In the case of amplitude detection only, sampling of the transmitted RF signal results in the index to the LUT 110 for indexing predistortion data relating to, for example, modification of magnitude for the predistorted signal. Optionally, predistortion data for both magnitude and phase are varied when a relationship between the magnitude and phase response of the RF power amplifier is known. Any such relationship is preferably pre-programmed into the adaptation control circuit, 107 or 207, prior to operation of the transmitter circuit, 100 or 200. In the preferred embodiment, when both amplitude and phase information are available, due to quadrature sampling of the transmitted RF signal, then magnitude and phase corrections are determinable without further information requirement about the PA 204.

Initial values are provided in the LUT at start-up of the transmitter circuit 100, 200 based upon known characteristics of the PA, 100 or 200, and in testing of the PA for various environmental factors. This LUT 110 is either in then in the form of a single index LUT, where for example only magnitude information about the sampled signal is used for indexing of the LUT, or if a receiver is used with a quadrature down-conversion mixer, as in the preferred embodiment of FIG. 2, and adaptation of phase correction is to be performed, then indexing predistortion data for attaining both amplitude and phase correction is performed in the LUT 210.

In operation each complex base-band value to be transmitted is preferably multiplied by an interpolated value derived from the LUT 210 before being provided to the pulse-shaping filter, which is either an analog or digital circuit. Small values of amplification do not require correction because common PAs are sufficiently linear at low power output levels. When an envelope detector is used to provide feedback, such as that illustrated in FIG. 1, such detectors have a limited dynamic range; however, since at low amplification no correction is required it is advantageous to focus the reduced dynamic range to regions of higher amplification in order to provide correction therefor.

The detected transmitted signal is supplied to the base-band as envelope only or in quadrature form. This is used to modify the look-up table to minimize the error in the transmitted signal using a pre-programmed algorithm.

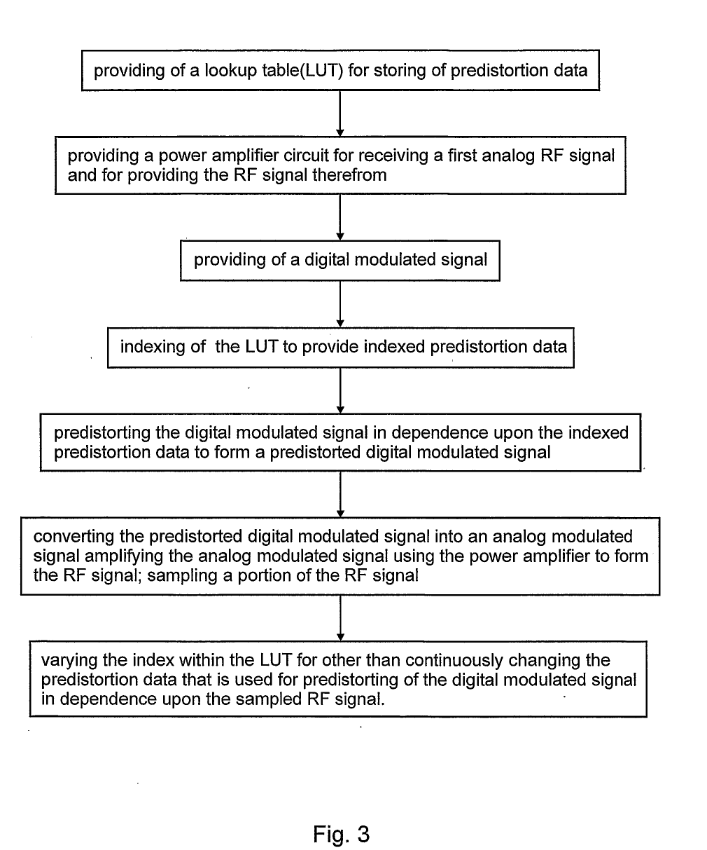

FIG. 3 summarizes the steps of operation for the transmitter circuits illustrated in FIGS. 1 and 2. A method of transmitting a RF signal comprising: providing of a lookup table (LUT) for storing of predistortion data; providing a power amplifier circuit for receiving a first analog RF signal and for providing the RF signal therefrom; receiving of a digital modulated signal; indexing of the LUT to provide indexed predistortion data; predistorting the digital modulated signal in dependence upon the indexed predistortion data to form a predistorted digital modulated signal; converting the predistorted digital modulated signal into an analog modulated signal; amplifying the analog modulated signal using the power amplifier to form the RF signal; sampling a portion of the RF signal; and, varying the index within the LUT for other than continuously changing the predistortion data that is used for predistorting of the digital modulated signal in dependence upon the sampled RF signal.

Prior art systems for pre-distorting RF signals prior to the power amplifier are available. However these prior art systems operate independently and require significant additional circuitry that render them unsuitable for use in low power wireless transmitters. The embodiments of the present invention advantageously combine pre-distortion with existing base-band processing circuitry and advantageously reuse existing receiver circuitry, thereby providing for reduced additional component cost over available prior art systems.

It will be apparent to a person of skill in the art that the predistorter is optionally capable of modifying its response in order to enhance performance. In a WLAN application the packet starts with a comb of pilot tones that have characteristics of a pulse. Processing the pilot tones provides coefficients for the look-up table. Another option is to begin transmitting a signal at low power and gradually increase the signal intensity as corrections are calculated.

Numerous other embodiments may be envisaged without departing from the spirit or scope of the invention.

1. A method of transmitting an amplified RF signal comprising:
providing a lookup table (LUT) for storing of predistortion data;
providing a power amplifier circuit for receiving a first analog RF signal and for providing the amplified RF signal therefrom;
receiving a digital modulated signal;
indexing the LUT to provide indexed predistortion data;
predistorting the digital modulated signal in dependence upon the indexed predistortion data to form a predistorted digital modulated signal;
converting the predistorted digital modulated signal into an analog modulated signal;
amplifying the analog modulated signal using the power amplifier to form the amplified RF signal;
sampling a portion of the amplified RF signal; and,
varying the index within the LUT for other than continuously changing the predistortion data that is used for predistorting of the digital modulated signal in dependence upon the sampled amplified RF signal.

2. A method according to claim 1 comprising:
providing a digital signal having a first predetermined symbol pattern concurrently with the digital modulated signal;
sampling a pre-defined portion of the amplified RF signal;
extracting a second predetermined symbol pattern from the amplified RF signal;
comparing the second predetermined symbol pattern to the first predetermined symbol pattern; and,
varying the index within the LUT in dependence the comparison.

3. A method according to claim 1 wherein the predistortion data is varied in dependence upon at least one of a temperature of the power amplifier and supply voltage and output load.

4. A method according to claim 1 wherein sampling the portion of the amplified RF signal comprises:
providing an amplitude detector with a predetermined dynamic range corresponding to higher amplitudes of the amplified RF signal in order to provide the sampling for varying the index within the LUT.

5. A method according to claim 4 comprising:
detecting with the amplitude detector the magnitude of the amplified RF signal;
determining an index within the LUT corresponding to a predistortion data for predistorting the digital modulated signal to correct the sampled amplified RF signal; and
feeding the determined index back to the LUT in order to effect the predistortion of the digital modulated signal to correct the sampled amplified RF signal.

6. A method according to claim 2 comprising:
varying the index within the LUT until the difference between the second predetermined symbol pattern and the first predetermined symbol pattern are approximately minimized.

7. A method according to claim 4 comprising:
detecting with the amplitude detector the magnitude of the amplified RF signal;
providing a predetermined relationship between a magnitude and phase response of the power amplifier circuit;
determining a phase of the amplified RF signal in dependence upon the predetermined relationship; and,
varying the index within the LUT in dependence upon the determined amplitude and phase of the amplified RF signal.

8. A method according to claim 1 wherein sampling the portion of the amplified RF signal comprises:
providing a receiver circuit with a quadrature down-conversion mixer;
quadrature sampling of the amplified RF signal with the receiver circuit; and,
detecting an amplitude and phase of the amplified RF signal.

9. A method according to claim 8 wherein the receiver circuit is a same receiver circuit used within a receive path of a transceiver system.

10. A method according to any of claim 1 comprising:
determining an index within the LUT corresponding to a predistortion data for predistoring the digital modulated signal to correct the amplitude and phase of the sampled amplified RF signal;
varying the index within the LUT in dependence upon the determined amplitude and phase of the sampled amplified RF signal.

11. A method according to claim 2 wherein the predistortion data is varied in dependence upon at least one of a temperature of the power amplifier and supply voltage and output load.

12. A method according to claim 3 comprising:
varying the index within the LUT until the difference between the second predetermined symbol pattern and the first predetermined symbol pattern are approximately minimized.

13. A method according to claim 4 comprising:
varying the index within the LUT until the difference between the second predetermined symbol pattern and the first predetermined symbol pattern are approximately minimized.

14. A method according to claim 2 wherein sampling the portion of the amplified RF signal comprises:
providing an amplitude detector with a predetermined dynamic range corresponding to higher amplitudes of the amplified RF signal in order to provide the sampling for varying the index within the LUT.

15. A method according to claim 14 comprising:
detecting with the amplitude detector the magnitude of the amplified RF signal;
providing a predetermined relationship between a magnitude and phase response of the power amplifier circuit;
determining a phase of the amplified RF signal in dependence upon the predetermined relationship; and,
varying the index within the LUT in dependence upon the determined amplitude and phase of the amplified RF signal.

16. A method according to claim 3 wherein sampling the portion of the amplified RF signal comprises:
providing a receiver circuit with a quadrature down-conversion mixer;
quadrature sampling of the amplified RF signal with the receiver circuit; and,
detecting an amplitude and phase of the amplified RF signal.

17. A method according to claim 1 comprising
providing a receiver circuit and,
wherein the receiver circuit is a same receiver circuit used within a receive path of a transceiver system.

18. A method according to claim 2 comprising:
determining an index within the LUT corresponding to a predistortion data for predistoring the digital modulated signal to correct the amplitude and phase of the sampled amplified RF signal;
varying the index within the LUT in dependence upon the determined amplitude and phase of the sampled amplified RF signal.

19. A method according to claim 3 comprising:
determining an index within the LUT corresponding to a predistortion data for predistoring the digital modulated signal to correct the amplitude and phase of the sampled amplified RF signal;
varying the index within the LUT in dependence upon the determined amplitude and phase of the sampled amplified RF signal.

20. A method according to claim 8 comprising:
determining an index within the LUT corresponding to a predistortion data for predistoring the digital modulated signal to correct the amplitude and phase of the sampled amplified RF signal;
varying the index within the LUT in dependence upon the determined amplitude and phase of the sampled amplified RF signal.
